(19) United States
(12) Patent Application Publication
(10) Pub. No.: US 2008/0072770 A1
(43) Pub. Date: Mar. 27, 2008

(54) Meat-smoking device for refrigeration

(76) Inventor: Fu Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/524,906

(22) Filed: Sep. 22, 2006

(51) Int. Cl. A23B 4/044

(52) U.S. Cl. 99/482

(57) ABSTRACT

The present invention includes a smoking cabinet, a central air supply system, and a refrigeration device. The central air supply system includes an air supply pipe and an air-draining pipe connected with the smoking cabinet. The other end of the air supply pipe and an air-draining pipe are connected with an air supply unit and an air-draining pump respectively. The refrigeration device includes a cooling pipe extending curvedly to the inside of the smoking cabinet for controlling the temperature between −2 to 7° C. for providing refrigeration. Thus, providing fresher and better quality meat and fish, especially sashimi.

### BACKGROUND OF THE INVENTION

1. Field of the Invention

The present invention relates to a meat-smoking device for refrigeration, and in particular to a meat-smoking device that keeps smoked meat (such as fish and meat) fresher, and provides a better quality of meat.

2. Description of Related Art

Conventional meat-smoking devices primarily produce and supply cooking smoke to keep meat fresh. A meat-smoking device is disclosed in Taiwan Patent No. tw563430 published on Nov. 21, 2003. The meat-smoking device includes a coconut shell-burning furnace, a cooling cylinder, a cooling water machine, an air compressor, a compression tank and an air supplying portion. An electrical plate is positioned within the furnace, and a plurality of filters is positioned within the cooling cylinder in communication with the furnace via a first conduit. The cooling water machine is respectively connected with ends of a first water supply pipe and a second water supply pipe. The first water supply pipe is connected in series with a cartridge-like standard filter jar and odor filtering jar. A plurality of nozzles is positioned at the other end of the first water supply pipe and inserted into the upper portion of the cooling cylinder. The nozzles sprinkle cooling water on the filters. The second water supply pipe communicates with the lower portion of the cooling cylinder. Moreover, the air compressor is connected with the cooling cylinder via a second conduit that is connected in series with a cartridge-like standard filter jar and odor filtering jar. The air compressor is connected with a third conduit and used to supply cooking smoke. The compression tank connects with a free end of the third conduit and is used to store the cooking smoke.

As shown in FIG. 1, the air supplying portion of the conventional meat-smoking device includes a smoking cabinet 90, a supporting frame 91, a trolley 92, and a central air supply system. The smoking cabinet 90 supplies the cooking smoke produced from the air supplying portion, and the supporting frame 91 has separate supporting plates 911. Several pieces of meat 93 can be placed on the supporting plate 911, and the smoking cabinet 90 is adapted to receive the supporting frame 91. The trolley 92 is used to support the supporting frame 91 and moves between the smoking cabinet 90 and predetermined locations. The central air supply pipe system includes air-draining pipes and air supply pipes respectively connected with the smoking cabinet 90. The air-draining pipes are used to drain air from the smoking cabinet 90 via an air-draining pump 94, and the air supply pipes are used to supply the cooking smoke into the smoking cabinet 90 via the compression tank 95. The conventional meat-smoking device uses the cooking smoke to cook meat so that the meat is preserved, sterilized and kept fresh.

However, the conventional meat-smoking device can also be used for cooking fish, such as sashimi, or cooking meat and cannot provide fresher and better quality meat.

U.S. Pat. No. 5,484,619 discloses a meat-smoking method and device. The meat-smoking device includes a smoke-generating chamber, a smoke-filtering unit, a smoke-cooling unit, and a smoking chamber. The smoke-generating chamber is used to generate smoke. The smoke-filtering unit filters out harmful materials from the smoke. The smoke-cooling unit cools the smoke from the filtering unit to between 0° and 5° C. The cooling smoke is introduced into the smoking chamber to smoke fish and meat.

U.S. Pat. No. 5,972,401 discloses a manufacturing process of tasteless super-purified smoke for freezing or chilling of treated seafood and meat. First, the smoke is produced, and then filtered until it becomes a tasteless super-purified smoke. Next, the manufactured smoke is used to treat seafood and meat. Finally, the treated seafood and meat can be frozen or chilled. The cooling temperature is between 0.1° C. and 7.8° C. The freezing temperature is between −12° C., −40° C., or −60° C. The processing manner involves filling a bag of seafood or meat with smoke, or filling a stage tank with the smoke, and then treating the seafood or meat.

U.S. Pat. No. 6,777,012 discloses a process for preserving fish. First, smoke is provided to smoke the fish to keep the fish fresh. Next, the smoke is removed. Secondly, ozone is provided to the fish to remove the smoke and bacillus from the fish. Finally, the treated fish are frozen, packaged, and preserved.

The above mentioned U.S. Pat. Nos. 5,972,401, 5,484,619, and 6,777,012, do not provide a better method of keeping fresh than the present invention.

### SUMMARY OF THE INVENTION

It is an object of the present invention to provide a meat-smoking device for refrigeration. The present invention provides fresher and meat of a better quality.

To achieve the above object, a meat-smoking device for refrigeration includes a smoking cabinet, a central air supply system, and a refrigeration device. The central air supply system includes an air-draining pipe and an air supply pipe respectively connected with the smoking cabinet. The other end of the air supply pipe is connected with an air supply unit that is used to supply the cooking smoke. The other end of the air-draining pipe is connected with an air-draining pump that drains the cooking smoke from within the smoking cabinet. The refrigeration device includes a cooling pipe extending to the inside of the smoking cabinet. The temperature inside the smoking cabinet is controlled between −2 to 7° C.

### BRIEF DESCRIPTION OF THE DRAWINGS

The present invention can be fully understood from the following detailed description and preferred embodiments with reference to the accompanying drawings, in which:

FIG. 1 is a perspective view of a conventional meat-smoking device;

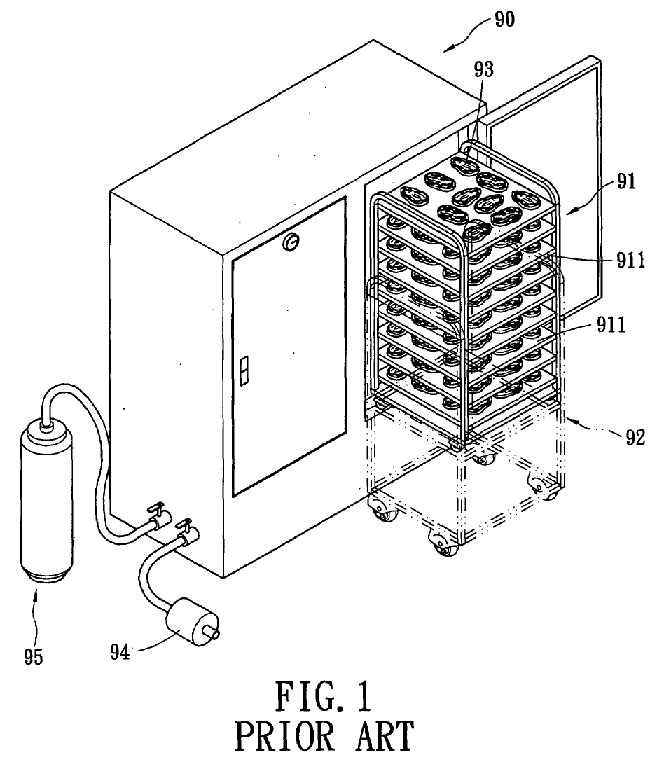

FIG. 2 is a perspective view of a meat-smoking device according to the first embodiment of the present invention;

FIG. 3 is a perspective view of a meat-smoking device in use according to the first embodiment of the present invention;

FIG. 4 is a perspective view of a meat-smoking device according to the second embodiment of the present invention; and

FIG. 5 is a perspective view of a meat-smoking device in use according to the second embodiment of the present invention.

### DETAILED DESCRIPTION OF THE PREFERRED EMBODIMENTS

The following detailed description is of the best presently contemplated modes of applying the invention. This description is not intended to be taken in a limiting sense, but is made merely for the purpose of illustrating general principles of embodiments of the invention. The scope of the invention is best defined by the appended claims.

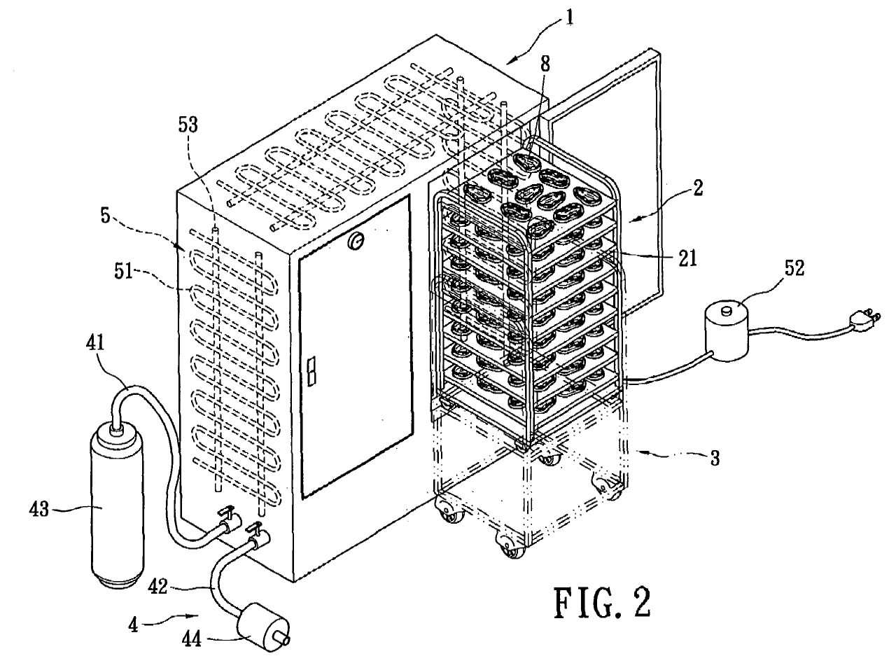

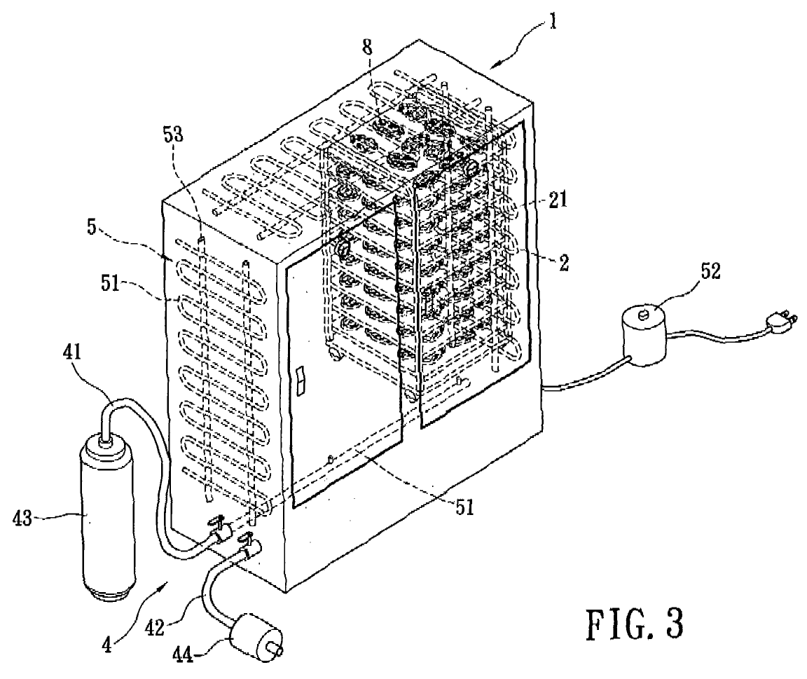

Reference is made to FIG. 2 and FIG. 3. FIG. 2 illustrates a perspective view of a meat-smoking device according to a first embodiment of the present invention. FIG. 3 illustrates a perspective view of a meat-smoking device in use according to the first embodiment of the present invention. The present invention relates to the central air supply system of the meat-smoking device. The central air supply system connects an air production system that is conventional and beyond the scope of the present invention. The description of the air production system has therefore been omitted.

According to the present invention, the meat-smoking device includes a smoking cabinet 1, a supporting frame 2, a trolley 3, a central air supply system 4, and a refrigeration device. The smoking cabinet 1 is hollow and receives the cooking smoke generated by the air production system. The volume of the smoking cabinet 1 can be changed to meet requirements. The smoking cabinet 1 can have either one-cabinet, two-cabinets, three-cabinets or four-cabinets to receive various types of supporting frames 2. According to the first embodiment, the smoking cabinet 1 has two-cabinets to receive two supporting frames 2.

The supporting frame 2 has separate supporting plates 21. Several pieces of meat 6 can be placed on the supporting plate 21, and the smoking cabinet 1 is adapted to receive the supporting frame 2. The trolley 3 is used to support the supporting frame 2 and moves between the smoking cabinet 1 and predetermined locations.

The central air supply system 4 includes an air supply pipe 41 and an air-draining pipe 42 respectively connected with one side of the smoking cabinet 1. The other end of the air supply pipe 41 is connected with an air supply unit 43 (also known as a compression tank). The air supply unit 43 is connected with the air production system (not shown) of the meat-smoking device and stores the cooking smoke. Moreover, the air supply unit 43 is used to supply the cooking smoke into the smoking cabinet 1 via the air supply pipe 41 so as to cook the meat 6. The other end of the air-draining pipe 42 is connected with an air-draining pump 44 for draining the air inside the smoking cabinet 1.

The refrigeration device 5 includes a plurality of cooling pipes 51. The cooling pipes 51 extend curvedly into the inside of the smoking cabinet 1. The cooling pipes 51 are disposed on the inside walls of the smoking cabinet 1. There is refrigerant inside of the cooling pipes 51. The cooling pipes 51 are connected with a cooling recycling structure, such as a compressing machine 52, a cooler, and an evaporator (not shown). Moreover, a plurality of protecting sticks 53 are disposed on the cooling pipes 51. The protecting sticks 53 are disposed a side wall of the smoking cabinet 1 that are near to the cooling pipes 51. The protecting sticks 53 prevent the supporting frame 2 from hitting the cooling pipes 51 or other elements.

Reference is made to FIG. 3. According to the present invention, meat 6 is placed on supporting plates 21 of the supporting frame 2 and positioned within the smoking cabinet 1 by pushing the trolley 3 to a predetermined position. Then, the air supply unit 43 is used to supply cooking smoke into the smoking cabinet 1 via the air supply pipe 41 for smoking the meat 6. After the meat has been smoked properly, the air-draining pump 44 is activated via the air-draining pipe 42 to drain the cooking smoke from within the smoking cabinet 1. The meat 6 is smoked via the cooking smoke so that the meat is preserved, sterilized and kept fresh.

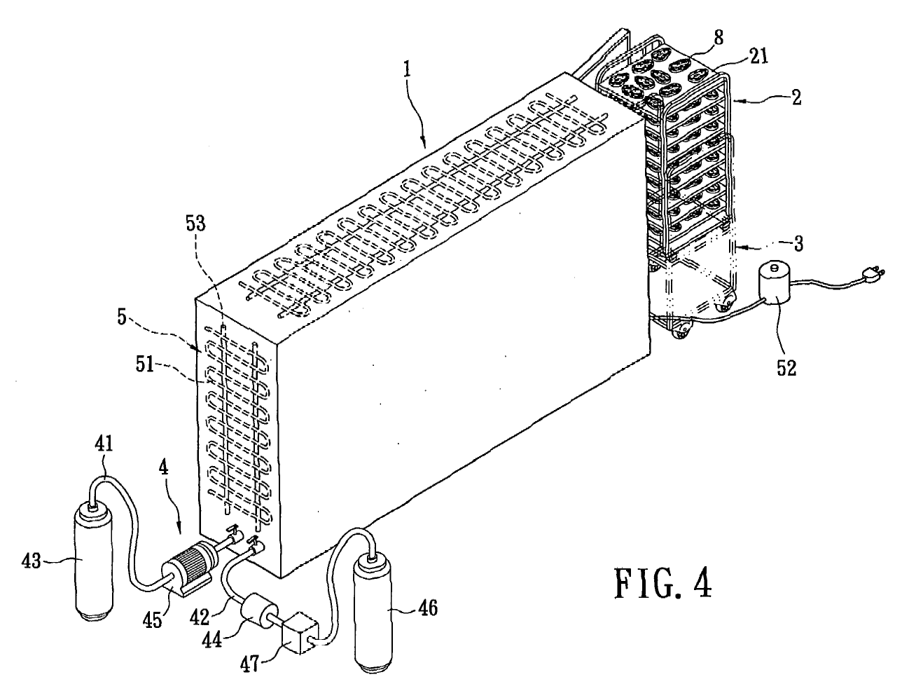

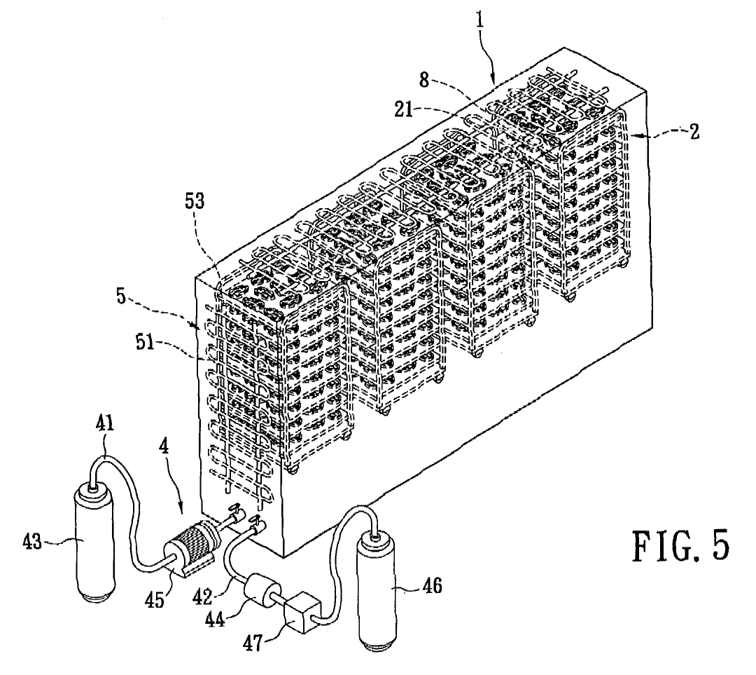

Referring to FIG. 4 and FIG. 5, the second embodiment of the present invention is shown. The smoking cabinet 1 has four cabinets to receive four supporting frames 2. The air supply pipe 41 is connected with a compression motor 45 positioned between the air supply unit 43 and the smoking cabinet 1 so that the cooking smoke produced by the air supply unit 43 is properly compressed. Thus, the cooking smoke is compressed at a pressure of between 2 to 20 Kg/cm² and supplied to the smoking cabinet 1. The other end of the air-draining pipe 42 is connected with an air-draining pump 44 that drains cooking smoke within the smoking cabinet 1 so that there a vacuum of −76 cm-Hg is created within the smoking cabinet 1. Moreover, the air-draining pump 44 is connected with an air-recycling unit 46 (compression tank) and used to drain and recycle the cooking smoke within the smoking cabinet 1. The air-draining pipe 42 is connected between the air-recycling unit 46 and the air-draining pump 45 and includes a filter unit 47 to filter out the recycled cooking smoke. Thus, dust in the smoking cabinet 1 is prevented from passing into the air-recycling unit 46.

Reference is made to FIG. 3. According to the present invention, meat 6 is placed on supporting plates 21 of the supporting frame 2 and positioned within the smoking cabinet 1 by pushing the trolley 3 to a predetermined position. Then, the air supply unit 43 is used to supply cooking smoke into the smoking cabinet 1 via the air supply pipe 41. The cooking smoke is compressed to between 2 and 20 Kg/cm² by the compression motor 45. The process of supplying compressed cooking smoke stops after a predetermined time. Next, the air-draining pump 44 is activated to drain the cooking smoke from within the smoking cabinet 1 so that the cooking smoke is collected by the air-draining pump 45 and sent back to the air-recycling unit 46. To achieve this, a vacuum of −76 cm-Hg is created within the smoking cabinet 1. The process of draining compressed cooking smoke stops after a predetermined time. The process of supplying and draining the cooking smoke from within the smoking cabinet 1 takes two to three hours. The process of cooking the meat is completed so that the meat is preserved, sterilized and kept fresh.

According to the present invention, the central air supply system 4 of the meat-smoking device includes the compression motor 45 and the air-draining pump 44 to supply and drain the compressed cooking smoke from within the smoking cabinet 1 repeatedly. Thus, the meat within the smoking cabinet swells and shrinks repeatedly so that the cooking smoke can penetrate the meat quickly. Two to three hours is required to complete the process of cooking the meat. So, compared to conventional meat-smoking devices, the present invention saves lots of time. Furthermore, when the present invention is applied to cooking fish, the present invention keeps the fish fresh.

The main object of the present invention is the refrigeration device 5 disposed within the smoking cabinet 1. The refrigeration device 5 includes the cooling pipe 51 extending to the inside of the smoking cabinet 1. After the process of cooking the meat has been started, the refrigeration device 5 is started to keep the temperature between −2 to 7° C. within the smoking cabinet. The meat-smoking device of the present invention is used for cooking fish or cooking meat, especial sashimi, and provides meat that is fresher and of a better quality.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A meat-smoking device for refrigeration, comprising:
a smoking cabinet; and
a central air supply system, including an air-draining pipe and an air supply pipe respectively connected with the smoking cabinet, the other end of the air supply pipe is connected with an air supply unit that is used to supply cooking smoke, and the other end of the air-draining pipe is connected with an air-draining pump that drains cooking smoke from within the smoking cabinet; and
a refrigeration device including a cooling pipe extending into the inside of the smoking cabinet, and controlling the temperature within the smoking cabinet to between −2 to 7° C.

2. The meat-smoking device as claimed in claim 1, wherein the smoking cabinet has one-cabinet.

3. The meat-smoking device as claimed in claim 1, wherein the smoking cabinet includes at least two cabinets.

4. The meat-smoking device as claimed in claim 1, wherein the air supply unit is connected with the air production system.

5. The meat-smoking device as claimed in claim 1, wherein the air supply pipe is connected with a compression motor which compresses the cooking smoke, and the air supply pipe is connected with a compression motor which compresses the cooking smoke.

6. The meat-smoking device as claimed in claim 5, wherein the air-draining pipe is connected between the air-recycling unit and the air-draining pump, and includes a filter unit.

7. The meat-smoking device as claimed in claim 1, further comprising a supporting frame and a trolley, and the supporting frame supports separate supporting plates and supports the meat, and the supporting plates are positioned within the smoking cabinet and the trolley supports the supporting frame.

8. The meat-smoking device as claimed in claim 1, wherein the cooling pipe is disposed on the inside walls of the smoking cabinet.

9. The meat-smoking device as claimed in claim 1, wherein the cooling pipe is connected with a compressing machine, a cooler, and an evaporator.

10. The meat-smoking device as claimed in claim 1, wherein the cooling pipe includes a plurality of protecting sticks disposed on a side wall of the smoking cabinet that is near to the cooling pipe.
